(19) United States
(12) Patent Application Publication
(10) Pub. No.: US 2009/0283542 A1
(43) Pub. Date: Nov. 19, 2009

(54) Receptacle for containers with flavouring agents

(76) Inventor: Rudiger Cruysberghs, Brussels (BE)

Correspondence Address: STABILPRESS INTERNATIONAL NV, HAACHTSESTEENWEG 1369, BRUSSELS, 1130, BE

(21) Appl. No.: 12/387,950

(22) Filed: May 11, 2009

(30) Foreign Application Priority Data
Apr. 1, 2008 (BE) BE2008/0204

(51) Int. Cl. B67D 5/56; B67D 5/06

(52) U.S. Cl. 222/129; 222/185.1

(57) ABSTRACT

A receptacle for at least one container with a flavouring agent (7), consisting of a frame (1,15), which extends around the periphery of a water vessel (2,14) of a dispenser (3,18), consisting of a foot, in such a manner that it is supported by the top (5), a bottom (19) or a bag in box dispenser (14) and an attachment for at least one container(7) with a flavouring agent, to mix this in a glass with water from a dispenser (3,18).

The present invention concerns a device consisting of a receptacle to which containers with flavouring agents are attached, as well as the manner in which this receptacle is placed over a beverage dispenser.

In particular, the invention concerns a receptacle, consisting of a frame to which containers with flavouring agents are attached and which is placed over a water bottle of a dispenser, in such a manner that the bottom of the frame is primarily supported by the top of the dispenser base.

A water dispenser consists of a water bottle, which is placed upside down and the outlet opening of which connects with a dispenser. The water is gravity-fed from the bottle and after activation of a nozzle by a user, into a cup located under the nozzle. Such a device is known from U.S. Pat. No. 2,725,725.

In the current dispensers an empty water bottle is usually replaced with a new full bottle, which is connected upside down to the dispenser.

In another case such dispensers consist of a refillable, transparent or otherwise, vessel in which the desired liquid is introduced. In other devices water is supplied via the water mains.

In addition, such devices are fitted with cooling or heating equipment.

Furthermore, dispensers exist such as the so-called bag-in-box, whereby a liquid in a flexible container, such as a bag, is enclosed by a second rigid casing. A nozzle connects with the flexible container and allows the user to dispense the contents of the inner container through the rigid casing. Such a device is known for instance from EP1826173.

The above-mentioned devices are also called water fountains or “water coolers” and are usually installed in public places or intended for domestic use. Such devices are placed on the floor or, in a smaller version, on a kitchen table or countertop.

Since not everyone, and certainly not children, appreciates the taste of water, it is not uncommon to add a flavouring agent to the water.

Such a device whereby a flavouring agent is added to a water dispenser is known from US2007012719. It concerns a dispenser with an automated system whereby single-use impregnated media must be introduced in the dispenser when filling a glass.

In CA2510733 a flavouring agent is added in the piping through which water is supplied via a water conduit in the dispenser.

Another device in accordance with WO0051475 provides for a platform attached to the water bottle, using the ribs on such a water bottle. The platform has at least one opening to insert the container with the flavouring agent.

In GB2403710 a bottle with fruit concentrate is screwed to the dispenser.

The disadvantage of the former devices is that the flavouring agent and liquid are mixed in the device. It is not possible for the user to dose the flavouring agent in accordance with his preferences.

The latter devices, however, use the water bottle or dispenser itself to attach the platform or permanently mount the bottle holder, respectively. In the first case, the ribs of the water bottle are used to accomplish this. However, this cannot be considered a universal device.

In GB2216491 for instance a water vessel is described for a cube-shaped water fountain, fitted with a handle to replace the water vessel.

Therefore, with this invention, we try to avoid the above-mentioned disadvantages.

Our invention consists of a frame, to which at least one container with flavouring agent is attached, in such a manner that this container is located above the dispensing nozzle of the dispenser. This allows the user to mix the flavouring agent with the water immediately prior to its consumption, by activating a selected container. Our invention preferably uses containers with flavouring agents which feature a pressure medium in the container, to facilitate the mixing with water. Such containers have already been described in our patent application WO2007/048209. Flavouring agents are mainly understood to mean liquid, semi-liquid, viscous concentrates, syrups, foams, suspensions, emulsions, etc. A first aspect of this invention allows the attachment of containers with flavouring agents, separate from the water bottle; the advantage is that this can be accomplished independently of the type of water bottle. In addition, this type of receptacle can also be used with a domestic water dispenser.

Since the flavouring agent is mixed with the water immediately prior to its consumption outside the dispenser and in accordance with the user's preferences, and the mixing is also enhanced by using containers with an internal pressure medium, this constitutes the invention's second aspect.

Another aspect of the invention concerns the fact that the frame can be adapted to the type of dispenser. Depending on the shape of the dispenser, the shape of the frame is adapted.

In addition, the containers with flavouring agents can be positioned at the desired height in the frame.

Since the receptacle for the containers with flavouring agents can be installed over the dispenser, without being attached to it, no additional time-consuming and specialised attachments are required. The owner or lessor of the dispenser can install the frame himself and without any additional technical procedures.

A final aspect of the invention concerns the application of advertisements to the frame. Sheets with advertisements, transparent or otherwise, can be inserted into the frame.

The invention is detailed below, with the corresponding drawings.

FIG. 1: Front view of the dispenser with a water bottle and a frame

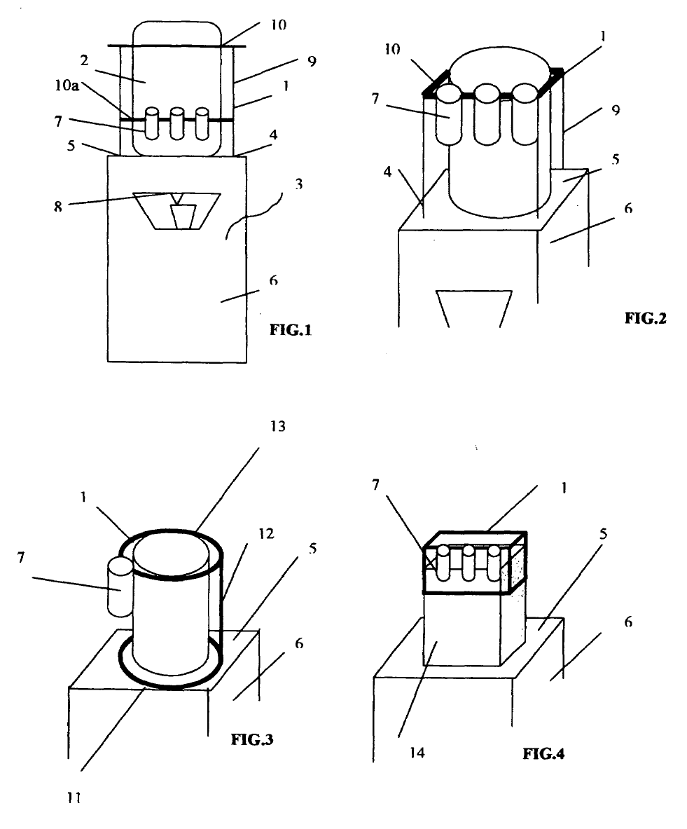

FIG. 2: Top view of the dispenser with a water bottle and a frame

FIG. 3: Side view of the dispenser with a water bottle and a top and bottom

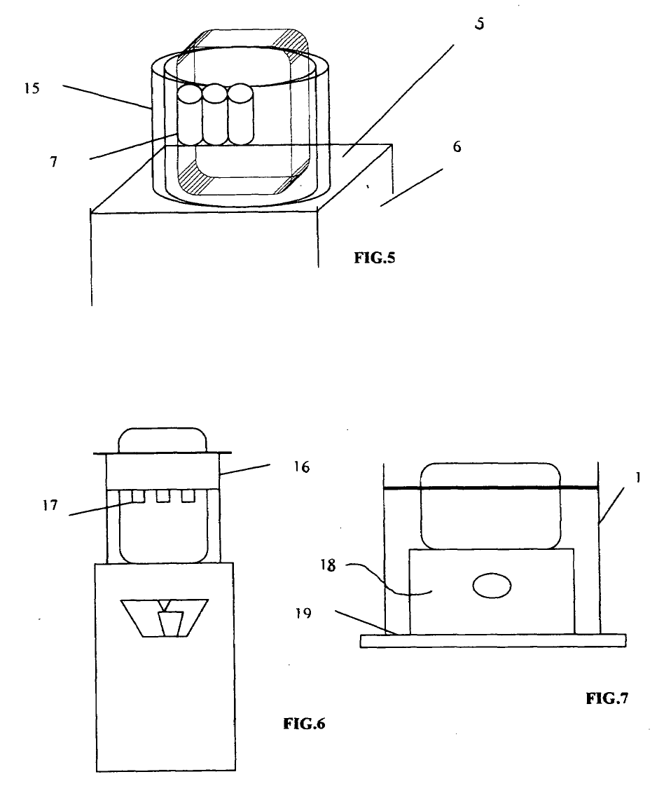

FIG. 4: Front view of the dispenser with a frame for bag in box

FIG. 5: Top view of the dispenser with a transparent frame

FIG. 6: Front view of the dispenser with a water bottle and a casing for containers with flavouring agents

FIG. 7: Front view with a frame on table

According to FIG. 1, the receptacle in accordance with the invention consists of a frame (1) placed around the water bottle (2) of a dispenser (3). The frame (1) is positioned in such a manner that the bottom (4) is supported by the top (5) of the base (6) of the dispenser (3).

At least one container with a flavouring agent (7) is attached to the frame (1). According to FIG. 1, three containers with flavouring agents (7) are installed above the dispensing nozzle (8) of the dispenser (3).

In FIG. 2 the containers with flavouring agents (7) are attached at the top of the frame (1).

According to a possible embodiment, it is also possible to attach other or spare containers (7) to another side of a cross-tie (10) of the frame (1).

According to FIG. 1, the frame (1) is fitted with at least two legs (9) and at least one horizontal cross-tie (10). In such an embodiment, the two legs (9) are located on the left-hand and right-hand side of the water vessel (2), respectively.

Both legs (9) extend over the entire lateral width of the frame. At the bottom, the legs (9) feature a foot (4) supported by the top (5) of the base (6).

In another possible embodiment, as indicated in FIG. 2, four legs (9) are provided for.

The frame in FIG. 1 features at least one cross-tie (10), located at the top of the frame (1). The cross-tie (10) connects the legs (9).

In a possible embodiment at least one cross-tie (10a) is height-adjustable. The cross-tie (10) is clamped between the legs (9) at the desired height. The end of the cross-tie (10) is clamped at the desired height in the slot of the legs (9).

According to the corresponding figures, the frame (1) is cube- or beam-shaped. In another possible embodiment, not illustrated in the figures, the frame is cylindrical, adapted to the tube shape of the water vessel. At least two cross-ties (10) on both sides of the frame (1) have a bent, convex shape.

According to FIG. 3, the frame consists of a ring-shaped foot (11) supported by the top (5) of the base (6) and featuring at least one vertical support (12). The support (12) features a ring-shaped top (13), to which at least one container with a flavouring agent (7) is attached. Both the foot (11) and/or the top (13) can have a circular, ovoid or rectangular shape, or have the form of a square or U-shape, adapted or otherwise to the shape of the water vessel. This receptacle is placed around the periphery of the water vessel.

FIG. 4 illustrates a frame (1) installed on a dispenser with a bag in box (14). The frame (1) can be supported by the bag in box (14), or can rest with its foot on the top (5) of the base (6). However, the latter is not illustrated in this figure. At least one container with a flavouring agent (7) is attached to the frame (1). The frame (1) is made of metal, plastic or wood. In a possible embodiment the frame (1) can be made of wire steel. The legs (9) are attached to the cross-ties (10) using welding technology, such as spot welding, or using glue. Depending on the application in which the frame (1) is used, the aesthetics of this frame (1) can be adapted during the manufacturing process. If the frame (1) is made of plastic, the aesthetics of the frame (1) can be adapted in the mould during the moulding process. For instance, the logo of the company where the water dispenser is installed can be added in the mould. In another possible embodiment, according to FIG. 5, the frame (15) consists of a solid sheet on all sides. This can be a single folded metal sheet or several sheets, fastened to each other. This sheet or these sheets can also be made of a transparent plastic. According to FIG. 5 the frame (15) can be made from a hollow tube of polycarbonate (plexiglass). However, this example is only illustrative and does not exclude any other materials or shapes.

The transparent frame (15) is placed over the water vessel. The foot is located on top of the dispenser. The sheet features clamps at the appropriate heights in order to attach the containers with flavouring agents. However, this is not detailed in the figures.

In addition, the frame (1) can be customised depending on the type of water vessel (2). The legs (9) closely fit around the periphery of the water vessel (2).

This is for instance illustrated in FIG. 4, where the frame closely fits around a bag in box (14).

The frame (1) can also feature a telescopic mechanism, allowing the cross-tie (10) and/or the legs (9) or the vertical support (12) to be adapted to the desired length. By fitting a part of the cross-tie (10) and/or the legs (9) with a hollow space, a second part with a smaller diameter can be clamped sliding in or out with the hollow part, allowing the desired length.

According to FIGS. 1 and 2 the containers with flavouring agents (7) are enclosed in a cylindrical casing. The casing is attached to a cross-tie (10,10a) by means of a clamping mechanism or screws.

As mentioned above, containers with a pressure medium are preferably used.

An activation mechanism, attached to the casing, allows the user to dispense the flavouring agent in a glass of water in order to obtain a mixture.

The bottom of the casing features an opening for a nozzle, which is not indicated in the figure. The container with a flavouring agent (7) is inserted in the casing with the nozzle penetrating the opening. A valve ensures the dispensing of the flavouring agent. According to a possible embodiment, a dosing valve can be used which has already been described in our Belgian patent application 2007/0343.

According to FIG. 6, several containers with flavouring agents (7) can be installed in a casing (16). The casing (16) is mounted on a cross-tie (10,10a).

As mentioned above, the cross-tie (10,10a) is height-adjustable and the casing (16), which houses the containers with flavouring agents (7), can be adapted to the user's preferences.

The casing (16) allows the installation of several containers. FIG. 6 illustrates a casing (16) with three containers featuring three nozzles (17). The containers (7) can be activated individually.

As mentioned above, water dispensers exist which can be placed on a table or countertop, usually for domestic use. FIG. 7 illustrates a dispenser (18), over which a frame (1) is to be placed. However, in this case the frame (1) is supported by the table (19) or the countertop. The containers with flavouring agents (7) can be attached to it, as in the previous description. For the sake of simplicity, this is not indicated in the figure.

In another possible embodiment the frame (1) features advertisements. A sheet with a message or logo can be clamped between two legs (9). This sheet can be clamped along the side of the dispenser (3). In addition, the sheet can also be mounted at the front, frontally in the user's field of vision. However, this is not indicated in the figures.

According to another possible embodiment, the frame is fitted with LED lighting, which is activated when a user approaches the dispenser. By means of a motion sensor, after a potential consumer is detected, the user's attention is drawn by activating the LED lighting. For instance, this lighting may depict an advertisement.

These LEDs are integrated in the frame or in the sheet placed in the frame.

If the frame is made from a solid plastic sheet, the LEDs are integrated in this sheet. In the case of an embodiment as illustrated in FIG. 5, the LEDs can be integrated in the transparent frame (15).

According to another embodiment, the frame is fitted with one or more flatscreens (S) which partly or entirely replace the function of the LED lighting.

The receptacle can be fitted with a manual, electric or pneumatic activation system to activate the container with a flavouring agent. The receptacle can also be fitted with a manual, electric or pneumatic dosing system to activate the container with a flavouring agent, thus obtaining a certain dose.

1. A receptacle for at least one container with a flavouring agent (7) which is to be installed over a dispenser (3,18), consisting of a frame (1,15), fitted with a foot supported by the top (5), bottom (19) or a bag in box dispenser (14) as well as an attachment to which at least one container with a flavouring agent (7) is attached, so that it extends around the periphery of a water vessel (2,14).

2. A receptacle for at least one container with a flavouring agent (7) which is to be installed over a dispenser (3,18) according to claim 1 and characterised by the fact that the frame (1) is fitted with a foot (4,11) which, by means of at least one vertical support (9,12) is connected with a top (10,13), to which at least one container with a flavouring agent (7) is attached.

3. A receptacle for at least one container with a flavouring agent (7) which is to be installed over a dispenser (3,18) according to claim 2 and characterised by the fact that the frame (1) is fitted with at least two legs (9) and at least one cross-tie (10) between the legs (9).

4. A receptacle for at least one container with a flavouring agent (7) which is to be installed over a dispenser (3,18) according to claims 2 or 3 and characterised by the fact that the frame (1) is fitted with four legs (9).

5. A receptacle for at least one container with a flavouring agent (7) which is to be installed over a dispenser (3,18) according to claims 2-4 and characterised by the fact that at least one container(7) is attached to an upper cross-tie (10).

6. A receptacle for at least one container with a flavouring agent (7) which is to be placed over a dispenser (3,18) according to claims 2-5 and characterised by the fact that a cross-tie (10,10a) is height-adjustable and is clamped between the legs (9).

7. A receptacle for at least one container with a flavouring agent (7) which is to be installed over a dispenser (3,18) according to claims 2-6 and characterised by the fact that the vertical support (9,12) is height-adjustable.

8. A receptacle for at least one container with a flavouring agent (7) which is to be installed over a dispenser (3,18) according to claims 6 or 7 and characterised by the fact that the vertical support (9,12) and/or a cross-tie (10) is fitted with a telescopic mechanism, because one part of the legs (9) or the vertical support (12) and/or a cross-tie (10) is hollow, which allows another part to be clamped in the hollow part, sliding in and out to the desired length.

9. A receptacle for at least one container with a flavouring agent (7) which is to be installed over a dispenser (3,18) according to the previous claims and characterised by the fact that the frame(1,15) is made of metal, plastic or wood.

10. A receptacle for at least one container with a flavouring agent (7) which is to be installed over a dispenser (3,18) according to claim 9 and characterised by the fact that the frame (1) is made of wire steel.

11. A receptacle for at least one container with a flavouring agent (7) which is to be installed over a dispenser (3,18) according to claims 1-11 and characterised by the fact that the frame(1,15) is tube-shaped, cube-shaped or beam-shaped, and adapted or otherwise to the shape of the water vessel (2,14).

12. A receptacle for at least one container with a flavouring agent (7) which is to be installed over a dispenser (3,18) according to claims 2-11 and characterised by the fact that the foot (11) and/or the top (10,13) has the shape of a circle, ovoid, rectangle, square or U-shape, adapted or otherwise to the shape of the water vessel (2,14).

13. A receptacle for at least one container with a flavouring agent (7) which is to be installed over a dispenser (3,18) according to the previous claims and characterised by the fact that the container(7) is fitted into a casing, which is attached to a top (10,10a,13).

14. A receptacle for at least one container with a flavouring agent (7) which is to be installed over a dispenser (3,18) according to claims 1-13 and characterised by the fact that several containers(7) are fitted in a casing (11), which is attached to a top (10,10a,13).

15. A receptacle for at least one container with a flavouring agent,(7) which is to be installed over a dispenser (3,18) according to claims 13 or 14 and characterised by the fact that the container(7) is fitted with a dosing valve or otherwise.

16. A receptacle for at least one container with a flavouring agent (7) which is to be installed over a dispenser (3,18) according to the previous claims and characterised by the fact that the container(7) is fitted with an internal pressure medium.

17. A receptacle for at least one container with a flavouring agent (7) which is to be installed over a dispenser (3,18) according to claims 3-11 and characterised by the fact that a sheet is clamped between at least two legs (9) of the frame(1) and features advertisements or a logo.

18. A receptacle for at least one container with a flavouring agent (7) which is to be installed over a dispenser (3,18) according to the previous claims and characterised by the fact that het frame(1) is fitted with LEDs, which are activated by means of a motion sensor.

19. A receptacle for at least one container with a flavouring agent (7) which is to be installed over a dispenser (3,18) according to claim 1 and characterised by the fact that the frame (15) consists of a single solid sheet on four sides or connected solid sheets and attachments for a container(7).

20. A receptacle for at least one container with a flavouring agent (7) which is to be installed over a dispenser (3,18) according to claim 19 and characterised by the fact that the sheet is made of a transparent plastic.

21. A receptacle for at least one container with a flavouring agent (7) which is to be installed over a dispenser (3,18) according to claim 19 or 20 and characterised by the fact that the frame(15) is tubular.

22. A receptacle for at least one container with a flavouring agent (7) which is to be installed over a dispenser (3,18) according to claims 20-21 and characterised by the fact that the sheet is made of polycarbonate.

23. A receptacle for at least one container with a flavouring agent (7) which is to be installed over a dispenser (3,18) according to claims 19-22 and characterised by the fact that the LEDs are integrated in the sheet.

24. A receptacle for at least one container with a flavouring agent (7) which is to be installed over a dispenser (3,18) according to claims 19-22 and characterised by the fact that one or more flatscreens are integrated in the sheet.

25. A receptacle for at least one container with a flavouring agent (7) which is to be installed over a dispenser (3,18) according to the claims and characterised by the fact that the receptacle is fitted with a manual dosing system.

26. A receptacle for at least one container with a flavouring agent (7) which is to be installed over a dispenser (3,18) according to the claims and characterised by the fact that the receptacle is fitted with an electric dosing system.

27. A receptacle for at least one container with a flavouring agent (7) which is to be installed over a dispenser (3,18) according to the claims and characterised by the fact that the receptacle is fitted with pneumatic dosing system.

28. A receptacle for at least one container with a flavouring agent (7) which is to be installed over a dispenser (3,18) according to the claims and characterised by the fact that the receptacle is fitted with a manual activation system.

29. A receptacle for at least one container with a flavouring agent (7) which is to be installed over a dispenser (3,18) according to the claims and characterised by the fact that the receptacle is fitted with an electric activation system.

30. A receptacle for at least one container with a flavouring agent (7) which is to be installed over a dispenser (3,18) according to the claims and characterised by the fact that the receptacle is fitted with a pneumatic activation system.

31. A receptacle for at least one container with a flavouring agent (7) which is to be installed over a dispenser (3,18) according to the claims and characterised by the fact that the receptacle is fitted with a manual activation system.
